(19) United States
(12) Patent Application Publication
(10) Pub. No.: US 2019/0035013 A1
(43) Pub. Date: Jan. 31, 2019

(54) AUTOMOBILE LEASING ASSISTANT

(71) Applicant: AutoDealy, LLC, Westlake Village, CA (US)

(72) Inventor: PHILIP N. BERARDI, Westlake Village, CA (US)

(73) Assignee: AutoDealy, LLC, Westlake Village, CA (US)

(21) Appl. No.: 16/046,601

(22) Filed: Jul. 26, 2018

Related U.S. Application Data
(60) Provisional application No. 62/537,385, filed on Jul. 26, 2017.

(51) Int. Cl. G06Q 30/06

(52) U.S. Cl. CPC G06Q 30/0645

(57) ABSTRACT

A Lease Information Exchange 110 provides serves as a portal between consumers 120 and one or more candidate automobile providers 131, 132, 133, 134, 135. The lease information exchange provides interfaces through which consumers can input inquiries 141 regarding leasing of an automobile and receive responses 142 regarding the lease. The lease information exchange 110 communicates with one or more candidate automobile providers 131, 132, 133, 134, 135 to solicit proposed lease proposals 152, 162, 172, 182, 192 from the candidate automobile providers 131, 132, 133, 134, 135. The lease information exchange 110 handles the interface to the consumer 120 without regard to the number of candidate automobile providers solicited and presents the information to the consumer 120 with clarity, visibiltiy, and easily understood language.

### BACKGROUND OF THE INVENTION

The present invention relates to a system for simplifying and improving the process of automobile leasing. The system enables interaction between a consumer who desires to lease a car, but has little understanding of the lease process or which lease parameters are most important, and a dealer or other source of leased automobiles. The system receives communication of general parameters regarding a consumer's desired vehicle and lease characteristics augments that as needed and communicates that to a dealer or other source of automobiles for lease. The communication may be in the context of an application or app, which allows the consumer to evaluate the more specific terms, make adjustments to parameters, and see the resulting effect on lease terms, costs, and other parameters.

### SUMMARY OF THE INVENTION

The present invention, in at least one embodiment, relates to a system for simplifying and improving the process of negotiating lease terms. Typically, the average consumer is not conversant with the various parameters including potentially variable inputs that determine lease terms, costs, and other parameters. Because of this lack of knowledge, the consumer is often unaware of potential cost savings, trade-offs, and negotiating points. Moreover, most consumers lack any insight into typical values that serve to define the lease terms, the general range of these parameters available for negotiation, and the impact of the variation of one or more parameters upon the upfront, backend, and overall cost associated with the lease. Consumers have not had the option to be able to interact with multiple source for leasing an automobile in an efficient manner, and have no facility for interacting with multiple candidate automobile providers in parallel via a single interface. The system also allows for the targeted communication and/or marketing of lease offers to consumers who have initiated, but not consummated a lease, and consumers, who based upon available information may be in the market for an automobile lease.

Although tools are available to advise consumers regarding prices being paid for automobiles, these primarily exist in the automobile sales context, e.g., KBB, Edmunds, and TrueCar. Such tools are limited in that they are based on self-reported data and do not account for the significant additional complexity involved in negotiating and assessing a lease. Moreover many such tools require purchases from only a limited number of participating car dealers. Although some tools and web sites are available for assistance of consumers who wish to lease a car, the tools generally lack sophistication, information, and ways of organizing that information and are not useful for assisting the consumer during the actual lease negotiation process.

Tools are needed both to provide information to the consumer, but also to allow the consumer to determine the impact of adjustments to the information. The first step is enabled by a communication system in which the consumer communicates basic information regarding the year, make, model, and desired features of the automobile they wish to lease as well as any other lease terms which they have identified as constraints. The consumer provides these parameters along with their location to a lease information exchange. The information may be provided via an app which can be downloaded to a smart phone or other handheld communications device, be provided via input to data fields in a web-based information form, be provided in a text or SMS message, be provided via email or be provided by other electronic digital communications methods. The web form or app may augment or pre-supply data fields based upon prior interactions with the consumer or other information, such as geo-location data, or web cookie information that is accessible to the web browser or app.

The lease information exchange is an information processing facility including communications interfaces allowing for communication with consumers and candidate automobile providers via electronic digital communications, such as the Internet (web or email interfaces), SMS, or other electronic communications. The lease information exchange also includes a data processing function, which allows it to access databases and/or data repositories containing lease information, information about consumers, and information about candidate automobile providers, and the general ability to parse and evaluate lease requests and lease proposals.

The lease information exchange then interfaces with a network of candidate automobile providers, which may include representatives of auto dealers, dedicated auto lease services, or other business or brokerages which lease automobiles on a retail or wholesale basis and provides the candidate automobile providers with the basic parameters of the lease request. Those candidate automobile providers who have, or can obtain, an automobile which meets the desired selection criteria, and can lease it within the any general parameters communicated by the lease information exchange, may respond with their specific initial lease terms.

The lease information exchange may optionally include a data acquisition and monitoring function to supplement and/or augment information provided by candidate automobile providers. The data acquisition function may be enabled through the scraping of web sites and available databases for information regarding available automobiles and lease terms. The lease information exchange may use the information to provide the consumer with information regarding available automobile and leasing options, including incentives, terms, etc., or to inform the negotiation process.

If a lease is consummated between the consumer and one of the candidate automobile providers as a result of the activities of the lease information exchange, the lease information exchange is compensated by the automobile provider. The compensation may be based upon pre-negotiated terms between the automobile provider and the lease information exchange, or, optionally, be part of the information communicated by the candidate automobile provider to the lease information exchange and vary for each potential deal. The system will communicate to the consumer the taxes and fees associated with lease.

The lease information exchange may also market lease offers and terms from one or more candidate automobile providers to members of the public. These offers may be communicated to consumers who have not immediately initiated a lease request, who the lease information exchange has determined may in the market for an automobile lease. These targeted consumers may include consumers who have previously made a lease request, but who have not entered into a lease or those that who available information (e.g., from scraping of public data or use of private marketing databases) indicates entered into a lease at a time in the past such that a standard lease term (e.g., 12, 24, 30, or 36 months) would soon be expiring. Lease offers may also be communicated via social media to consumers who have visited sites or had online activities, which would indicate an interest in an automobile lease. The offers may also be communicated to those consumers who have downloaded the associated app, but not initiated a lease request and/or entered into a lease.

The lease information exchange can also provide information about leasing offers to potential consumers who have subscribed to the service. For example, a consumer may not wish to accept any lease offers from any candidate automobile providers at the time the consumer has submitted a lease request, but may wish to subscribe to be informed if any better offers become available at a later date.

The lease information exchange may interact with the candidate automobile providers serially, i.e., providing the information to first one candidate automobile provider, with a specified period of time for response, and then, if no response is received, communicating with another candidate automobile provider. Alternatively, the lease information exchange may communicate with multiple candidate automobile providers in parallel. If communicating with multiple candidate automobile providers and receiving more than one proposal, the lease information exchange evaluates the responses received from the candidate automobile providers based upon the exchange's selection criteria. The lease information exchange then selects a proposal from one of the candidate automobile providers and communicates the proposed terms and information to the consumer. The consumer is provided with at least some of the baseline parameters determinative of the lease cost in a form which allows the consumer to see how the lease cost has been calculated. The information may be provided via an app which can be downloaded to a smart phone or other handheld communications device, be provided via a private web-based information form which may accessed by the consumer, be provided in a text or SMS message, be provided via email, or be provided by other electronic digital communication methods.

In conjunction with the information provided by the lease information exchange to the consumer or as a separate application, the consumer may be provided with a calculator which provides them with ability to adjust the parameters provided by the lease information exchange, which has built in the relationships between the various lease parameters. This ability may be provided via a separate app or as part of and at which facilitates and enables communication between the consumer and the lease information exchange.

The consumer may then communicate to the lease information exchange whether they would like to accept the communicated lease parameters or decline them. If the consumer chooses to decline the lease terms, they may communicate to the lease information exchange which lease parameters, typically cost, rendered the proposal unacceptable and by how they would need to be adjusted. Based on this information the lease information exchange may determine whether it would be feasible to make the deal by decreasing the amount to be received by the lease information exchange and dedicating the decreased amount to meeting the consumers request, or by seeking modified terms from the automobile provider, or some combination of both. Additionally, if the initially selected candidate automobile provider cannot or is unwilling to satisfy the modified proposal from the consumer, the lease information exchange may communicate the now altered parameters to the other candidate automobile providers to see if they can satisfy the consumer's request.

Although primarily intended for use in leasing negotiations, the system may also be used for automobile purchasing negotiations. Such use may be enabled by the substitution of purchase incentives terms for lease incentives and terms and the simplification of the financial calculations by the elimination of lease specific financial factors.

After the lease information exchange has found a candidate automobile provider who can provide a responsive automobile at terms acceptable to the consumer, the lease information exchange will confirm the agreement in principle between the consumer and the automobile provider and make logistical arrangements for the execution of the lease deal and delivery of the automobile. Such arrangements may include the issuance of identification credentials, e.g. a unique voucher or confirmation code, which allow the consumer to identify themselves to the selected automobile provider and confirm the details of the lease and vehicle.

### DETAILED DESCRIPTION

In the following description of the preferred embodiments, reference is made to the accompanying drawings which show by way of illustration specific embodiments in which the invention may be practiced. Wherever possible, the same reference numbers will be used throughout the drawings to refer to the same or like parts. It is to be understood that other embodiments may be utilized and structural and functional changes may be made without departing from the scope of the present invention.

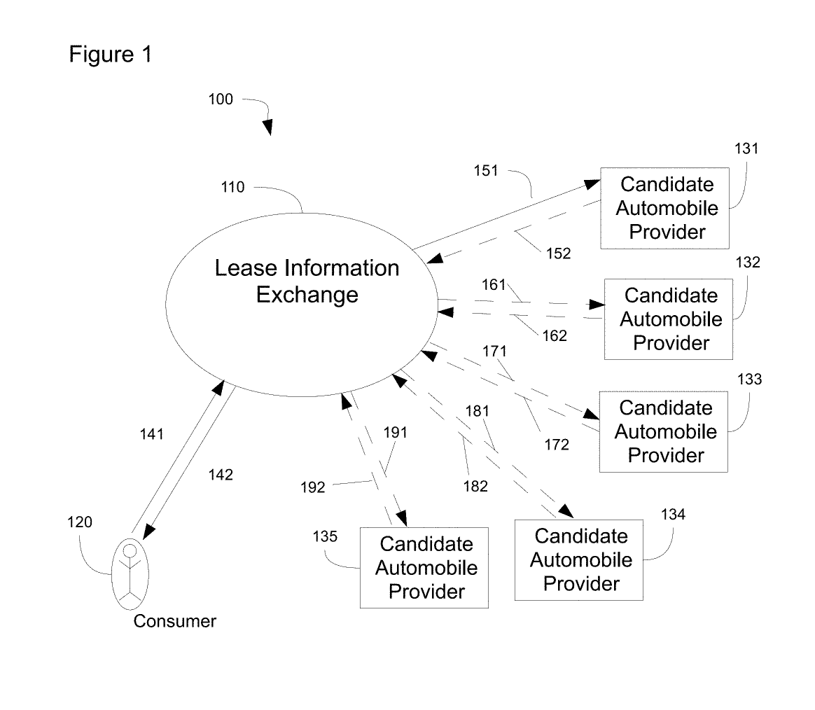

FIG. 1 illustrates the basic parties engaged in the auto lease process 100 in one embodiment of the invention. A consumer 120 interested in leasing a car communicates 141 with the lease information exchange 110 providing information regarding their desired lease. This information will include a specification of the characteristics of the automobile the consumer wishes to lease and any lease constraints the consumer wishes to provide to the lease information exchange 110. The lease information exchange 110 then communicates 151 with a candidate automobile provider 131 requesting a lease proposal. The candidate automobile provider 131 may respond 152 with a lease proposal, a rejection of the request, or may not respond at all. This response 152 may, optionally, take the form of the candidate automobile provider manually or automatically completing pre-existing fields in a web-based form ultimately hosted by the Lease Information Exchange. When the candidate automobile provider does provide a response, the lease information exchange may, where feasible, verify the veracity of the information, e.g. confirming that manufacturer incentives identified in the offer are consistent with those advertised by the manufacturer and that the manufacturer's suggested retail price for the vehicle is correct.

The lease information exchange may, in parallel with its communication 151 with the first candidate automobile provider 131, communicate 161, 171, 181, 191 its request for a lease proposal to other candidate automobile providers 132, 133, 134, 135. It would be obvious to one of ordinary skill that the number of candidate automobile providers is only constrained by practical business limitations such as the maximum effective size of the lease information exchanges business network or practical geographic limitations. When operating in a parallel proposal mode, the lease information exchange may receive 152, 162, 172, 182, 192 multiple lease proposals. The lease information exchange must then apply one or more selection critierion to select a proposal to communicate 142 to the consumer 120. The nature and choice of selection criterion are a business choice. For example, a lease information exchange 110 may have a preferred automobile provider, it may stand to make more income from one proposal than another, or the consumer cost may be lower from another proposal.

Alternatively, to parallel operation with the candidate automobile providers 131, 132, 133, 134, 135, the lease information exchange may wait for a rejection 152 from the first candidate automobile provider 131, or a lack of response within a predefined period of time, before initiating communication 161 with a second candidate automobile provider 132. If a rejection is communicated 162 by the second candidate automobile provider 132, then the process continues with subsequent candidate automobile providers in turn.

After receiving an acceptable lease proposal from a candidate automobile provider, the lease information exchange will communicate 142 the proposal to the consumer 120. If no acceptable lease proposal is received, the lease information exchange 110 will communicate that fact to the consumer 120.

The interaction illustrated in FIG. 1, as described above is initiated by the consumer 120, the interaction may, in some instances, be initiated by the candidate automobile provider(s), 131, 132, 133, 134, 135. In this interaction, the lease information exchange communicates or markets 142, lease offers 152, 162, 172, 182, 192 from one or more of the candidate automobile provider(s) 131, 132, 133, 134, 135 to one or more targeted consumers 120.

The lease information exchange 110, although identified as an exchange provides more than simply the exchange of information. The exchange provides the entire consumer facing interface for the system. Providing a simple, self-explanatory, cohesive interface for the consumer, who is unlikely to be familiar with the particulars of vehicle leasing or the relative importance of common lease terms is a major advantage of the present invention. This interface may consist of communications parsing systems that read and parse emails, text messages or SMS message to determine the terms of the basic lease request. Additionally, the interface may be configured to process social media requests and communications for the same information. The consumer facing interfacing may alternatively comprise web forms or app inputs or a chat bot interface emulating a human interaction.

Although on the candidate automobile provider side of the interface, the provider is more likely to be familiar with the basic lease terms, providing the information in a cohesive efficient manner is also important expediting the process. The same communications interfaces used on the consumer facing side may be used with the candidate automobile providers as well as interfaces to standard EDI protocols may be provided.

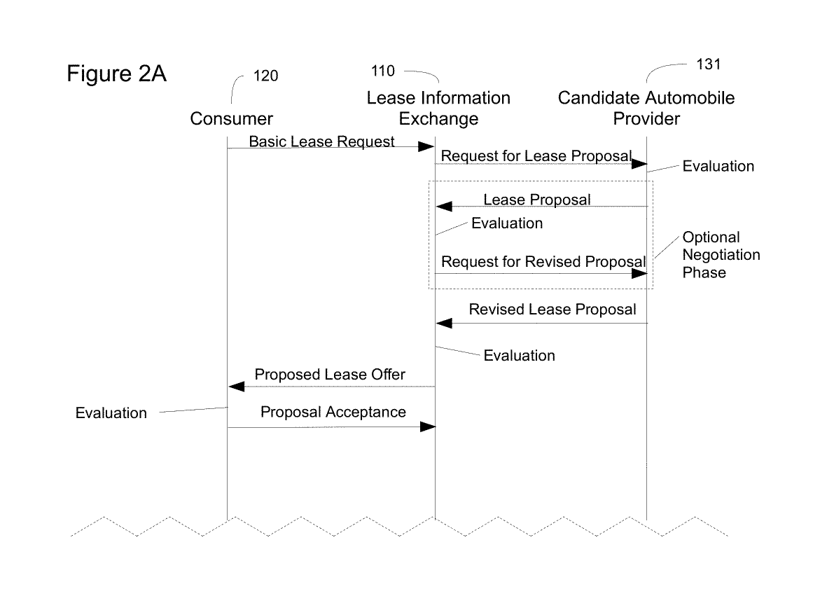

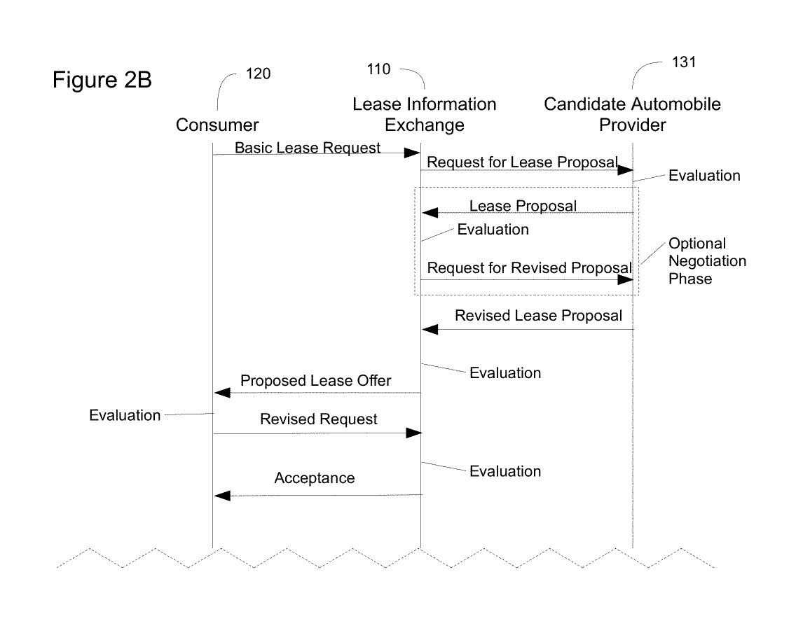

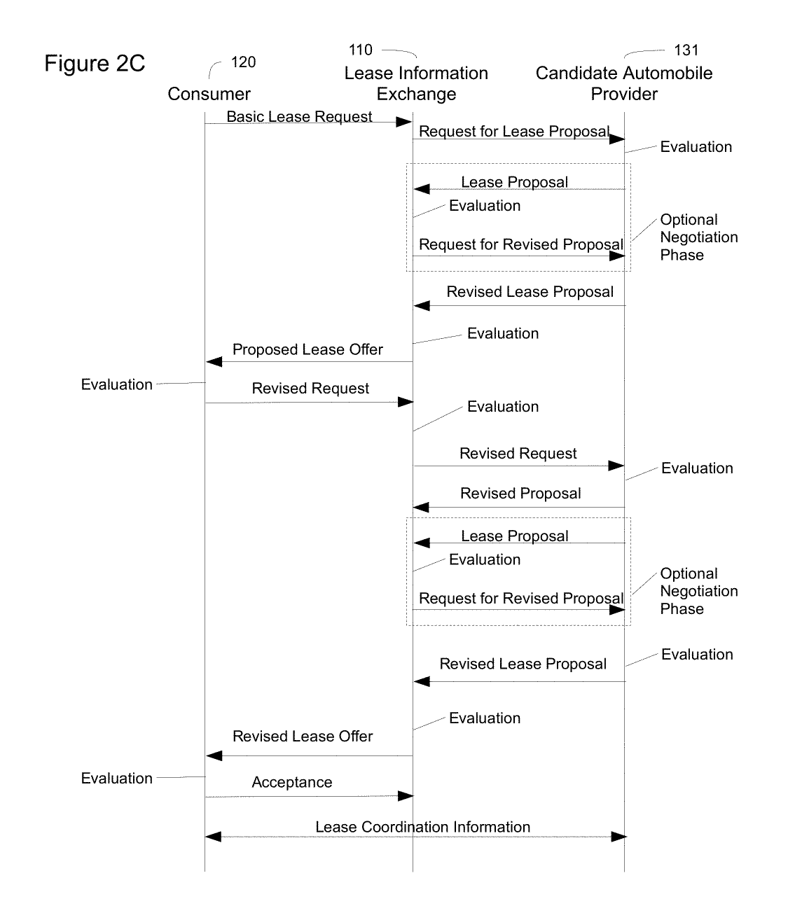

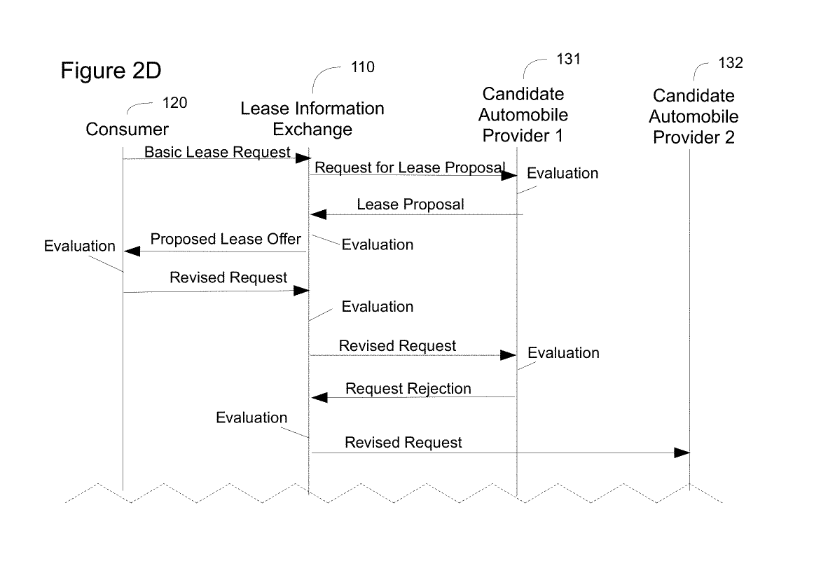

FIGS. 2A through 2D illustrate the information flow between the consumer 120, lease information exchange 110, and a first and second candidate automobile provider 131, 132.

FIG. 2A illustrates the most basic information exchange. The consumer 120 communicates a basic lease request to the lease information exchange 110, which then generates a request for a lease proposal which is communicated to a first candidate automobile provider 131. The candidate automobile provider 131, then provides a lease proposal to the lease information exchange 110. Alternatively (not shown) the candidate automobile provider 131 may provide a rejection to the lease information exchange 110 or provide no response at all. After receiving a lease proposal, the lease information exchange 110 will evaluate the proposal and may optionally engage in negotiation with the candidate automobile provider 131 regarding the lease terms. After the lease information exchange 110 has received an acceptable proposal from the candidate automobile provider 131, the lease information exchange will communicate a form of the proposed lease offer to the consumer 120. After an evaluation, the consumer 120 may communicate a proposal acceptance or rejection (not shown) to the lease information exchange 110.

FIG. 2B illustrates an alternate information flow in which the consumer 120 does not accept the initial proposed lease offer. Rather, the consumer 120 provides a revised request to the lease information exchange 110. In this embodiment of the information flow, the lease information exchange 110 evaluates the revised request from the consumer 120, determines that the revised request terms can be accepted without revising the lease proposal, e.g., it can be absorbed within the lease information exchange's 110 margins and communicates the acceptance of the revised request to the consumer 120.

FIG. 2C illustrates an alternative information flow in which, after receiving the revised request from the consumer 120, the lease information exchange 110 determines that it cannot accommodate the revised request from the consumer 120 without receiving a revised proposal from the candidate automobile provider 131. The lease information exchange 110 then communicates a revised request for a lease proposal to the candidate automobile provider 131, who in turn, after evaluation, provides a revised lease proposal to the lease information exchange 110. The lease information exchange 110 may engage in a negotiation phase with the candidate automobile provider 131. After receiving an acceptable proposal from the candidate automobile provider 131, the lease information exchange 110, in turn communicates a revised lease offer to the consumer 120. The consumer 120 then communicates its acceptance to the lease information exchange 110 which will then coordinate the lease information and execution with the consumer 120 and the selected candidate automobile provider 131. Alternatively, the consumer may reject the revised lease offer (not shown) or provide a further revised request (not shown).

FIG. 2D illustrates an alternative embodiment in which, after receiving the revised request for lease proposal from the lease information exchange 110, the first information candidate automobile provider 131 rejects the revised request for lease proposal. The lease information exchange 110, then communicates the revised request for lease proposal to the second candidate automobile provider 132 and resumes the latter stages of the information flow illustrated in FIG. 2C.

The operator of the lease information exchange has numerous options for generating revenues from facilitating the lease negotiation process. These options can include receiving payment from the selected candidate automobile provider in the form of an incentive payment or commission; can include direct compensation from the consumer, such as fee for service or a fee added to the monthly payment; or can include the retention of a portion of any savings that the system was able to obtain for the consumer over baseline or reference lease terms, e.g., a commission on lease savings or a commission on the spread between the MSRP and the final capitalized cost of the vehicle.

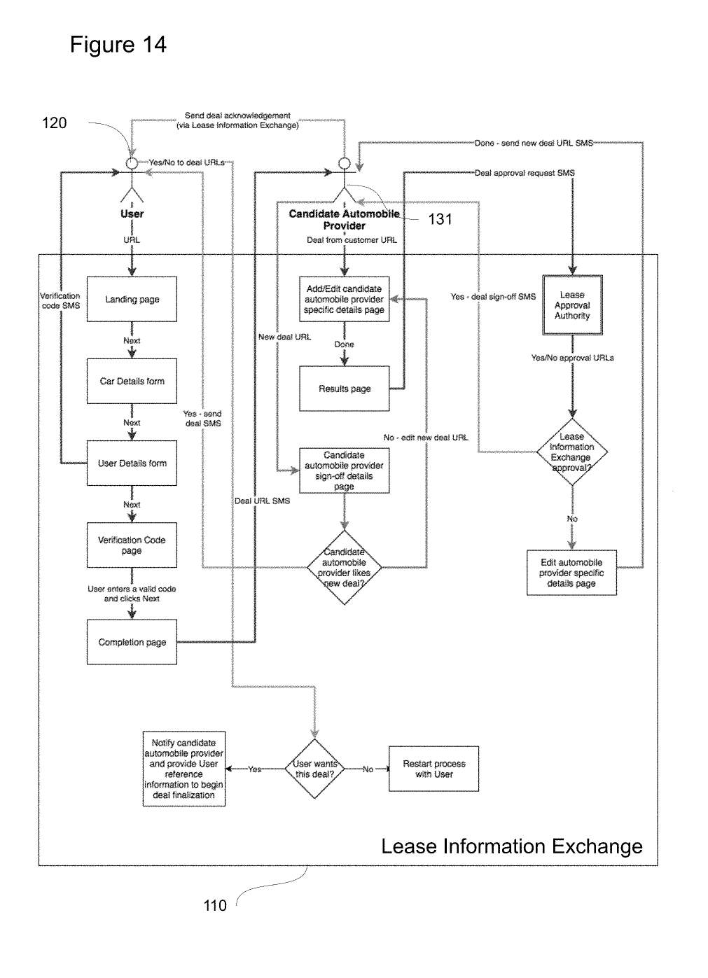

FIG. 14 illustrates a process flow for an implementation of an embodiment of the invention. A user 120 initiates interaction with the lease information exchange 110 through a URL to a landing page. The lease information exchange through one or more web pages or web forms. After completion and verification of entry the information is sent to a candidate automobile provider 131. Who interfaces with lease information exchange 110. The starting point for the interaction with of the candidate automobile provider 131 with the lease information exchange 110 is the verified deal information from the customer URL. The candidate automobile provider 131 provides the specific details of their offer and interacts with the lease information exchange 110 to generate a deal that the candidate automobile provider 131 likes and which is accepted by a lease approval authority within or overseeing the lease information exchange 110. After the candidate automobile provider 131 and the lease information exchange 110 have generated a deal that is mutually acceptable, it is communicated to the user 120, who will decide if he or she wishes to accept the deal or not. If accepted the lease information exchange notifies the candidate automobile provider 131 and provides user reference information to allow the finalization and consummation of the deal. If the user 120 does not want the deal, then the deal generation process begins again.

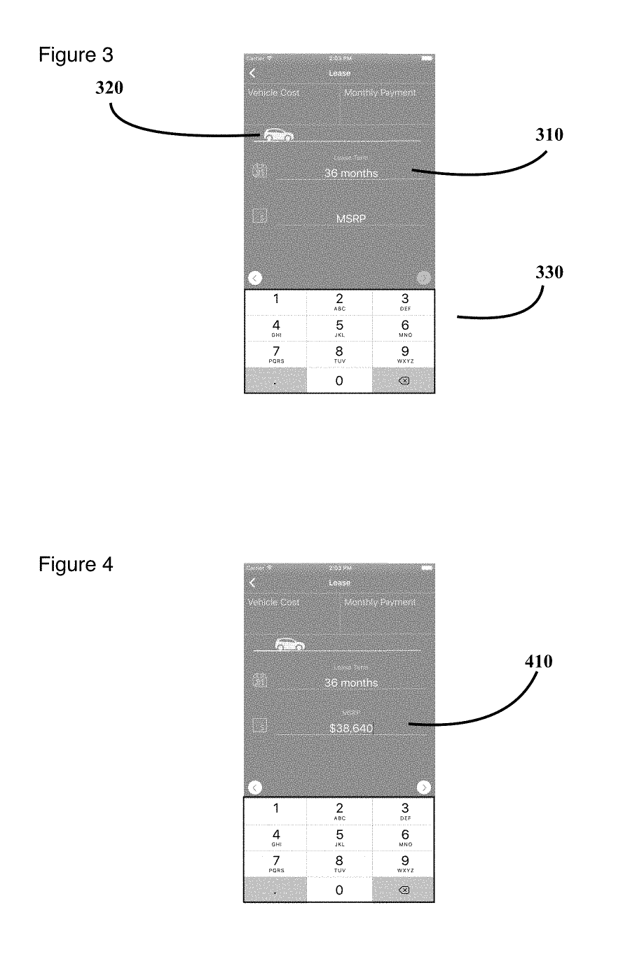

In addition to the lease information exchange system, the present invention may include a calculator that incorporates the relationships between the financial lease parameters. FIGS. 3 through 13, illustrate screens of said calculator. Although FIGS. 3 through 13 illustrate the calculator as an embodiment for iOS, in particular for the iPhone, it would be obvious to one of ordinary skill that it could be implemented on many computer platforms and operating systems, including Mac OS, Windows, and Android.

FIGS. 3 and 4 illustrates a basic screen layout comprising an input keypad 330, a graphical progress display 320, an input field for the lease term 310 and for the Manufactured Suggested Retail Price (MSRP) of the vehicle 410. Although not shown, the calculator may optionally provide help and definitional information on the screen, to explain the meaning of terms and how they are used to the consumer. It would be obvious to one skilled in the art that this information might also be made available via pull-downs or information links.

The calculator may be used by a consumer to explore the range of their options during pre-negotiation consideration or be used to aid the consumer in in interactive negotiation of a lease from an automobile dealer or auto lessor. In the latter context, the calculator allows the consumer to independently confirm that the lease term calculations are performed correctly and in the appropriate order and to assist the consumer to ask for the appropriate input information to ensure that the consumer has visibility into the important financial terms of the lease and savings opportunities.

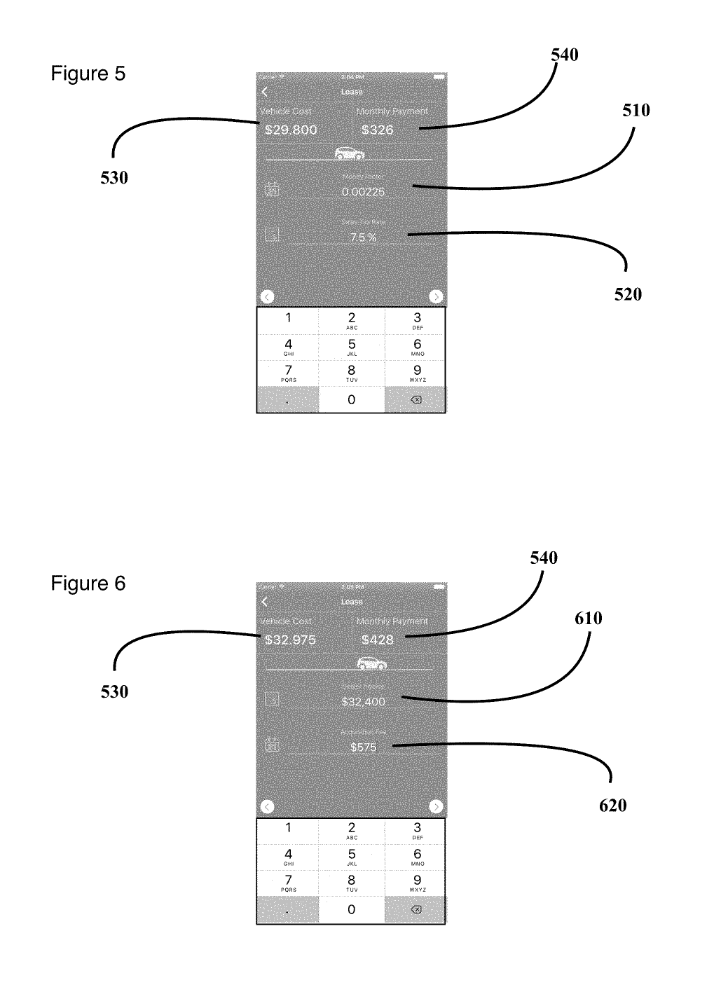

FIG. 5 illustrates the screen for input of the lease money factor 510 and sales tax rate 520. The working calculation of vehicle cost 530 and monthly lease payment 540 based on input information is also shown.

FIG. 6 through 8 allows the consumer to provide detailed inputs related the cost of the vehicle in lieu of simply using the MSRP. refinements to the input cost of the vehicle and track savings resulting from this more detailed approach. FIG. 6 illustrates the screen for input of the dealer invoice amount 610 and acquisition fee 620.

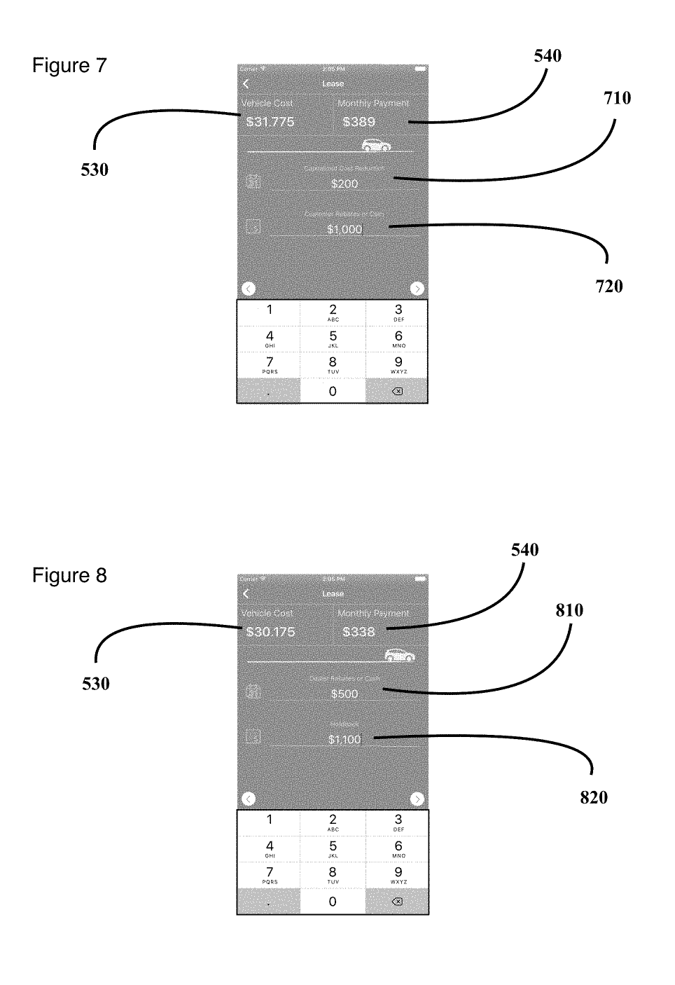

FIG. 7 illustrates the screen for inputting more detailed reductions to the cost of the vehicle, the capitalized cost reduction 710 and any consumer rebate or cash down payment 720 provided by the consumer. It should be noted that as additional information is provided, the vehicle costs 530 and monthly payment 540 fields are adjusted.

FIG. 8 illustrates dealer related inputs to determine the ultimate lease cost, any dealer rebate or cash incentive 810 and any dealer holdbacks 820. The vehicle cost 530 and monthly payment 540 are updated finally and the graphical progress indicator 320 shows completion.

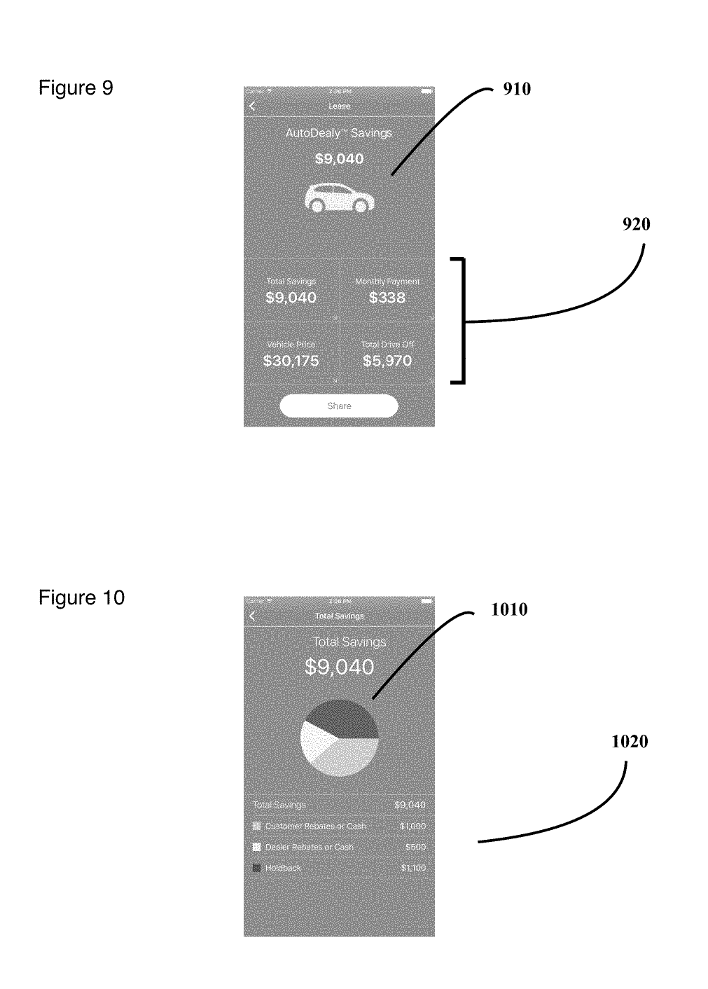

FIG. 9 illustrates a first summary screen in which the overall savings based on the use of the detailed inputs and calculation of actual vehicle cost to the dealer is shown 910. Additionally, other key characteristics of the lease including vehicle price, monthly lease payment, and total due at drive-off are displayed 920.

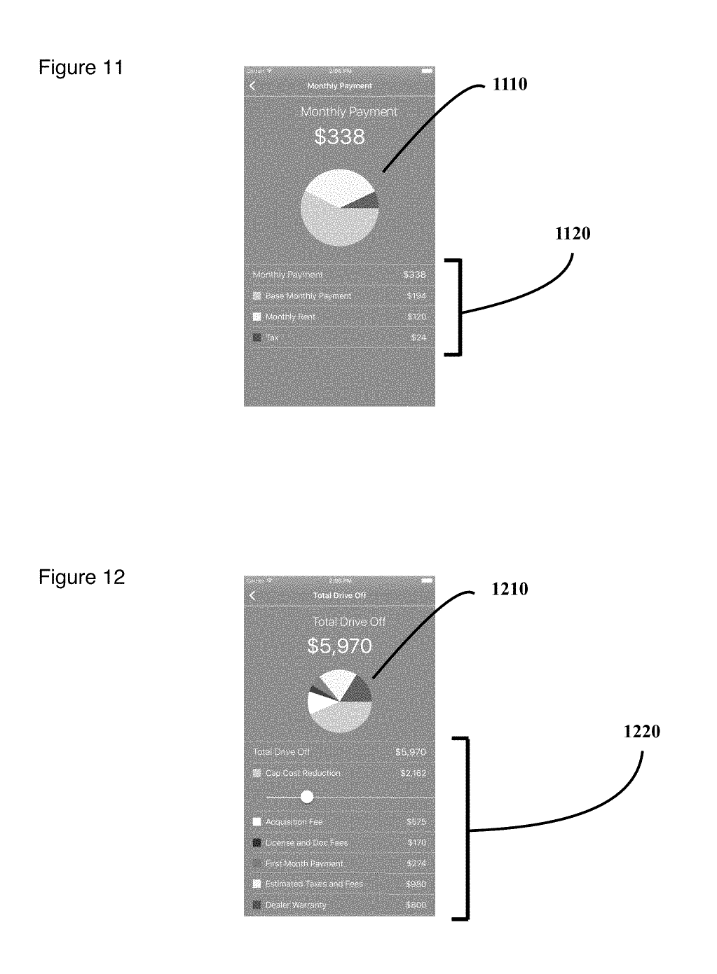

FIG. 10 through 12 illustrate the breakdowns of the key characteristics of the lease. FIG. 10 illustrates graphically 1010 and numerically 1020 a breakdown of the savings; FIG. 11 illustrates graphically 1110 and numerically 1120 a breakdown of the lease monthly payment components; and FIG. 12 illustrates graphically 1210 and numerically 1220 the breakdown of the total cost due at drive-off.

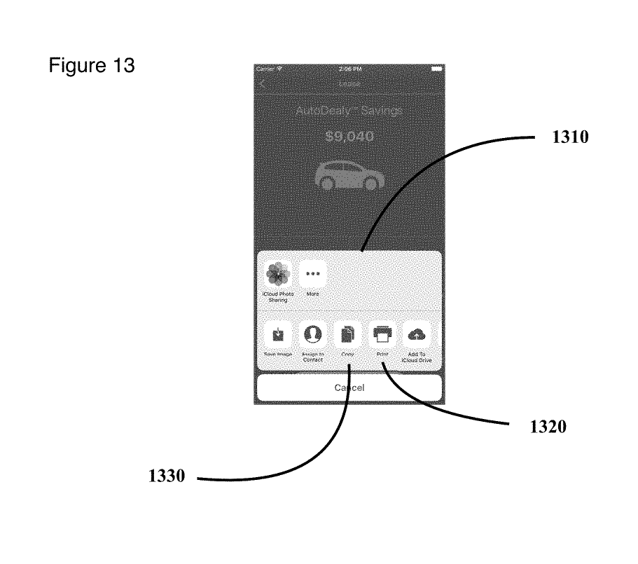

Finally, FIG. 13, provides an interface 1310 where by the lease information from the calculator may be shared or communicated to others or other apps, including copying 1330 the information for pasting elsewhere, and printing the information.

The basic numerical relationships of the terms in the calculator are defined and related as shown below. The calculator will choose the lower “Vehicle Cost Without Fee” based upon two possible formulae for that value.

Vehicle Cost Without Fee=Capitalized Cost-Cap Cost Reduction-Customer Rebates Or Cash−Dealer Rebates or Cash−Holdback Formula 1:

Vehicle Cost Without Fee=Dealer Invoice-Cap Cost Reduction-Customer Rebates Or Cash−Dealer Rebates or Cash−Holdback Formula 2:

Related formulae used in the calculator include:

$$Vehicle Cost = Vehicle Cost Without Fee + Acquisition Fee$$

$$Base Monthly Payment = \frac{\begin{matrix}Vehicle Cost Without Fee - \\ ( M S R P * Residual Value Percentage )\end{matrix}}{Terms of the Lease}$$

$$Monthly Rent = [ Vehicle Cost Without Fee + ( M S R P * Residual Value Percentage ) ] * Money Factor$$

$$PreTax Monthly Lease Payment = Base Monthly Payment + Monthly Rent$$

$$Monthly Tax = PreTax Monthly Lease Payment * Sales Tax Rate$$

$$TOTAL MONTHY PAYMENT = PreTax Monthly Payment + Monthly Tax$$

$$Total Savings = M S R P - Vehicle Cost Without Fee$$

$$TOTAL DUE AT DRIVE \text{-} OFF = Capitalized Cost Reduction + Acquisition Fee + License and Doc Fees + First Monthly Payment + Estimated Taxes and Fees + Dealer Warranty$$

Where,

FIRST MONTHLY PAYMENT=TOTAL MONTHLY PAYMENT

Additional the calculator may be configured to use geo-location data or consumer location input to determine the appropriate locality-dependent taxes and fees to include in the lease calculation. Additionally, the calculator will provide options to show the effect of the spreading of the payment of the Acquisition Fee or the entire Total due at Drive-Off across the lease term.

There is disclosed in the above description and the drawings, an apparatus, and method for simplifying and improving the process of automobile leasing. that fully and effectively overcomes the disadvantages associated with the prior art. However, it will be apparent that variations and modifications of the disclosed embodiments may be made without departing from the principles of the invention. The presentation of the preferred embodiments herein is offered by way of example only and not limitation, with a true scope and spirit of the invention being indicated by the following claims.

What is claimed is:

1. A lease information exchange comprising;
a first communication interface allowing for communication between a consumer and the lease information exchange;
a second communications interface allowing for communication between the lease information exchange and at least one candidate automobile provider;
wherein the first communications interface receives a basic lease request from the consumer;
wherein the basic lease request from the consumer is input via a series of forms completed by the consumer;
wherein the lease information exchange uses the information contained in the basic lease request to provide a request for lease proposal to the at least one candidate automobile provider;
wherein the at least one candidate automobile provider provides a lease proposal to the lease information exchange;
wherein the lease information exchange compares the lease proposal from the at least one candidate automobile provider with the information contained in the basic lease request from the consumer and if the lease proposal is consistent with the information in the basic lease request, designates the lease request as an acceptable lease proposal;
wherein if the lease information exchange determines that it has received only one acceptable lease proposal from the at least one candidate automobile providers, the lease information exchange communicates the lease proposal to the consumer; wherein the first communications interface is an automated electronic digital communication system;
wherein if the lease information exchange determines that it has received a plurality of acceptable lease proposals from the at least one candidate automobile providers, the lease information exchange evaluates the lease proposal from each of the plurality of candidate automobile providers based upon a selection criteria and the lease information exchange communicates the lease proposal, which best meets the selection criteria to the consumer;
wherein the first communications interface is an automated electronic digital communication system.

2. The system of claim 1, wherein the selection criteria are based, at least in part, upon a prioritization of lease parameters provided by the consumer.

3. The system of claim 1, wherein the series of forms completed by the consumer are implemented via web forms accessed via a web-browser.

4. The system of claim 1, wherein the series of forms completed by the consumer are implemented in an application on a smartphone or hand-held tablet.

5. The system of claim 1, wherein in response to the communication of the lease proposal to the consumer, the lease information exchange receives from the consumer either an acceptance of the lease proposal, a rejection of the lease proposal, or a lease revision request.

6. The system of claim 5, wherein if the lease information exchange receives the lease revision request from the consumer, the lease information exchange uses the information in the lease revision request to prepare a revised request for lease proposal to a second at least one or more candidate automobile provider, wherein the second at least one candidate automobile provider provides a second lease proposal to the lease information exchange;
wherein the lease information exchange compares the second lease proposal from the second at least one candidate automobile provider with the information contained in the revised lease request from the consumer and if the second lease proposal is consistent with the information in the revised lease request, designates the second lease request as an acceptable revised lease proposal;
wherein if the lease information exchange determines that it has received only one acceptable revised lease proposal from the second at least one candidate automobile providers, the lease information exchange communicates the revised lease proposal to the consumer; wherein the communications interface between the lease information system and the consumer is an automated electronic digital communication system;
wherein, if the lease information exchange determines that it has received a plurality of acceptable revised lease proposals from the second at least one candidate automobile providers, the lease information exchange evaluates the revised lease proposal from each of the plurality of candidate automobile providers based upon a selection criteria and the lease information exchange communicates the revised lease proposal, which best meets the selection criteria to the consumer; wherein the communications interface between the lease information system and the consumer is an automated electronic digital communication system.

7. The system of claim 5, wherein if the lease information exchange receives the acceptance of the revised lease proposal, the lease information exchange notifies the candidate automobile provider from which the revised lease proposal was received of the acceptance.

8. The system of claim 4 wherein the application incorporates a calculator tool for determining automobile lease savings comprising:
a plurality of input screens allowing for input of vehicle cost, lease terms, dealer costs and incentives, and rebates;
internal logic for determining the vehicle cost, savings over lease cost based on vehicle manufacturer's suggested retail price, monthly lease payment, and total drive off cost;
a display for illustrating a component breakdown of the total savings over lease cost based on the vehicle manufactured suggested retail price;
a display for illustrating a component breakdown of the monthly lease payment; and
a display for illustrating a component breakdown of the total drive off cost.

9. A lease information exchange comprising;
a first communication interface allowing for communication between a consumer and the lease information exchange;
a second communications interface allowing for communication between the lease information exchange and at least one candidate automobile provider;
wherein the lease information exchange receives, via the second communications interface, a lease proposal from at least one candidate automobile provider;
wherein the lease information identifies one or more potential consumers to communicate the lease proposal to, based on selection criteria indicating an interest on the part of the consumer in an automobile lease; and
wherein the lease information exchange communicates the lease proposal to the one or more potential consumers via the first communications interface.

10. The lease information exchange of claim 9, wherein the selection criteria indicating interest on the part of the potential consumer in an automobile lease comprises prior interactions between the lease information exchange and the potential consumer.

11. The lease information exchange of claim 9, wherein the selection criteria indicating interest on the part of the potential consumer is based upon data relating to a prior automobile lease entered into by the potential consumer.

12. The lease information exchange of claim 9, wherein the selection criteria indicating interest on the part of the potential consumer is based upon the potential consumer having viewed a particular web site.

13. The lease information exchange of claim 9, wherein the selection criteria indicating interest on the part of the potential consumer is based upon the potential consumer's use of social media.
